(19) United States
(12) Patent Application Publication
(10) Pub. No.: US 2021/0224822 A1
(43) Pub. Date: Jul. 22, 2021

(54) INTELLIGENT ELECTRONIC ATOMIZATION SYSTEM WITH AUTHENTICATION ANTI-COUNTERFEITING MECHANISM

(71) Applicants: Yao-An Tsai, Taipei City (TW); Hao-Yang Tsai, Taipei City (TW)

(72) Inventors: Yao-An Tsai, Taipei City (TW); Hao-Yang Tsai, Taipei City (TW)

(21) Appl. No.: 16/748,171

(22) Filed: Jan. 21, 2020

(51) Int. Cl. G06Q 30/00; A24F 40/65; A24F 40/50; H04W 12/00; H04W 12/06

(52) U.S. Cl. CPC G06Q 30/0185; A24F 40/65; H04W 12/06; H04W 12/00409; A24F 40/50

(57) ABSTRACT

In an intelligent electronic atomization system with an authentication anti-counterfeiting mechanism, a wireless communication module of a main body of an intelligent electronic atomization device is connected to a smart handheld device of a user before being used, so that authentication of user identification can be performed through the smart handheld device and a cloud server. After an atomizing member has been combined with the main body, the main body and the atomizing member perform mutual interpretation operations in every series of inhaling and exhaling actions. After a protocol has been interpreted as correct, the atomizing member sends a dynamic password to the main body to perform interpretation. The main body immediately wakes up the atomizing member after the main body has interpreted the dynamic password as correct. Finally, the main body transmits a driving current to the atomizing member.

### BACKGROUND OF THE INVENTION

### (1) Field of the Invention

The invention relates to an intelligent electronic atomization system with an authentication anti-counterfeiting mechanism, and more particularly to an electronic atomization device capable of achieving the anti-counterfeiting and youth smoking prevention objectives through a smart handheld device and an authentication method of a dynamic password.

### (2) Description of the Prior Art

According to statistics, the global smoking population is increasing year by year, and the age group thereof further tends to decrease. In addition, many research reports indicate that smoking causes many different illness conditions, so each government advocates and implements quit smoking policies and counsels smoking persons to quit smoking every year. The main danger of the cigarette is the tar oil generated after burning, and the tar oil contains thousands of different carcinogens. To this end, many research and development manufacturers have developed many products that can replace cigarettes, and the so-called electronic atomizer has become more popular in recent years. The liquid for replacing the cigarette is mainly heated and atomized to provide the atomized substances to be smoked by the user who requires the nicotine. Although the electronic atomizer is free from generating the tar oil, its contents will be added with harmful substances if no proper control mechanism is provided. Recently, some users using the electronic atomizers encounter the case of death. In addition, the age of the purchaser is not effectively restricted at present. Therefore, how to effectively control the users and the contents of the electronic atomizer will be a problem to be currently solved by many governments.

### SUMMARY OF THE INVENTION

A main objective of the invention is to provide an intelligent electronic atomization system with an authentication anti-counterfeiting mechanism, wherein a wireless communication module of a main body of an intelligent electronic atomization device is connected to a smart handheld device of a user before being used, so that authentication of user identification can be performed through the smart handheld device and a cloud server. After an atomizing member has been combined with the main body, the main body and the atomizing member perform mutual interpretation operations in every series of inhaling and exhaling actions. After a protocol has been interpreted as correct, the atomizing member sends a dynamic password to the main body to perform interpretation. The main body immediately wakes up the atomizing member after the main body has interpreted the dynamic password as correct. Finally, the main body transmits a driving current to the atomizing member.

### BRIEF DESCRIPTION OF THE DRAWINGS

FIG. 1 is a first schematic block diagram showing the invention.

FIG. 2 is a second schematic block diagram showing the invention.

FIG. 3 is a third schematic block diagram showing the invention.

FIG. 4 is a schematic view showing an embodiment of the invention.

### DETAILED DESCRIPTION OF THE PREFERRED EMBODIMENTS

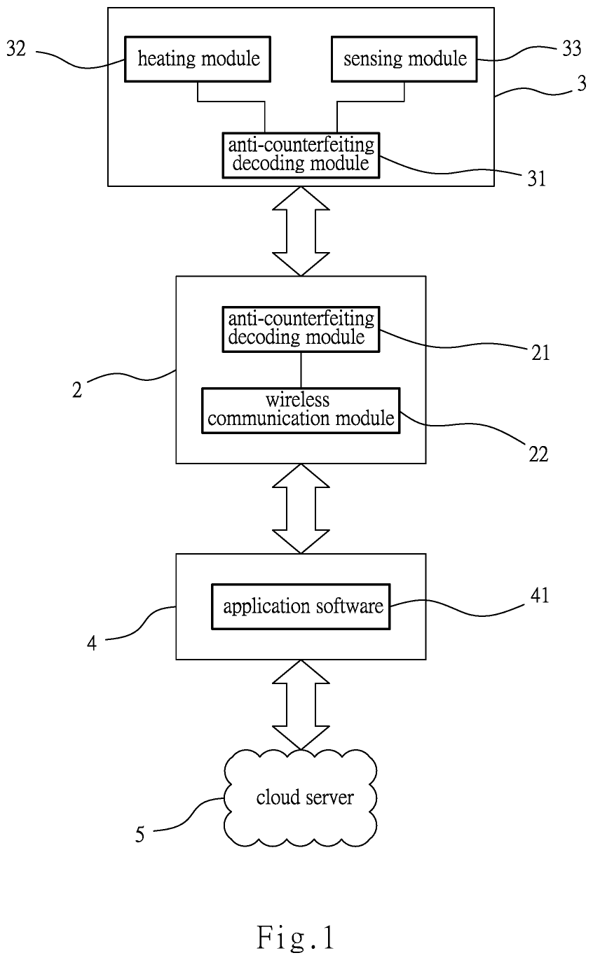

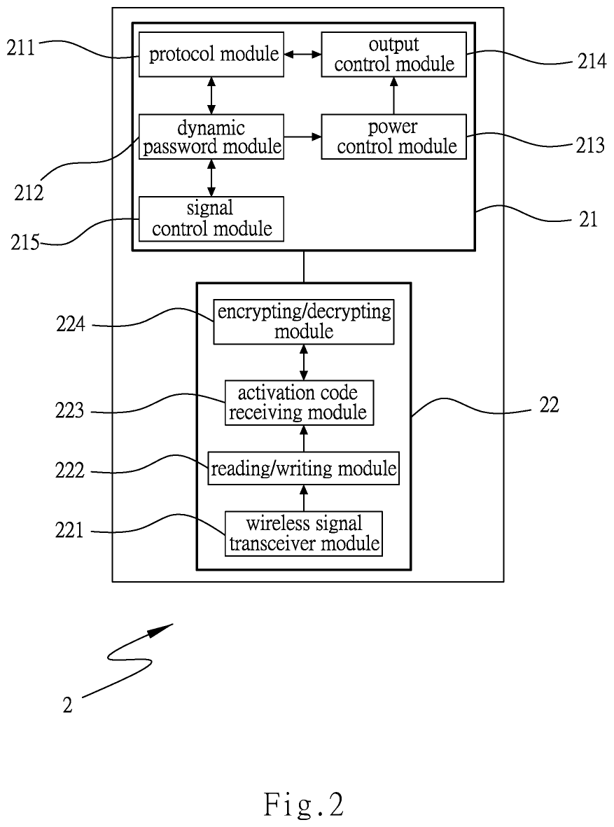

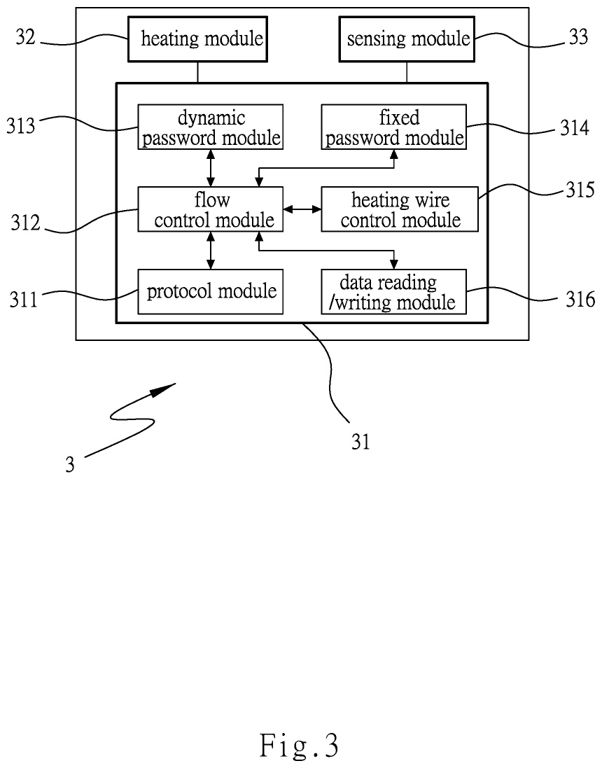

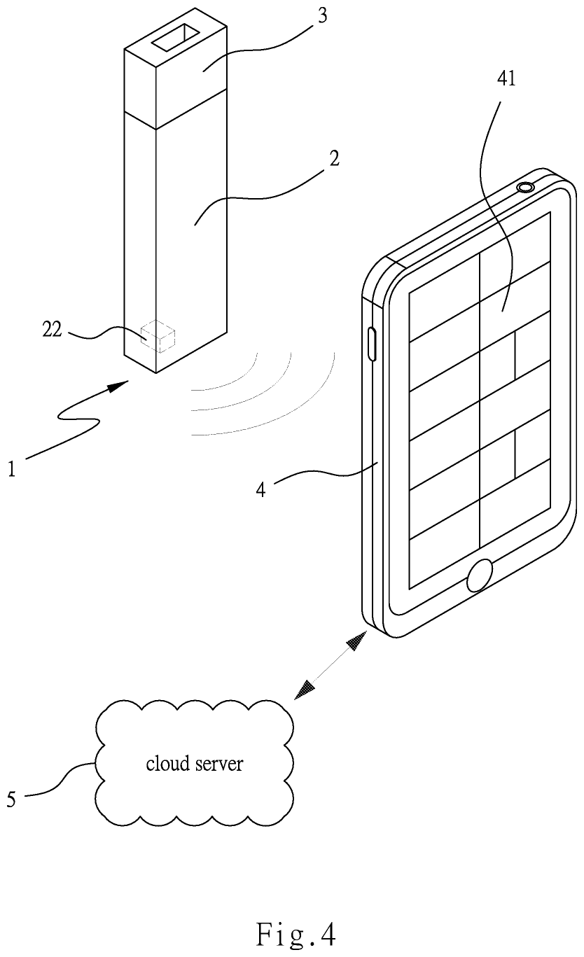

FIGS. 1 to 3 are schematic block diagrams showing the invention, and FIG. 4 is a schematic view showing an embodiment of the invention. Referring to FIGS. 1 to 4, it is clearly obtained that an intelligent electronic atomization system of the invention includes an intelligent electronic atomization device 1, a smart handheld device 4 and a cloud server 5.

The intelligent electronic atomization device 1 mainly includes a main body 2 and an atomizing member 3, wherein an anti-counterfeiting decoding module 21 and a wireless communication module 22 are disposed in the main body 2, and an anti-counterfeiting module 31, a heating module 32 and a sensing module 33 are disposed in the atomizing member 3.

The smart handheld device 4 is installed with application software 41, and connected to the main body 2 through the wireless communication module 22 of the main body 2.

The cloud server 5 is connected to the smart handheld device 4.

The wireless communication module 22 of the main body 2 includes a wireless signal transceiver module 221, a reading/writing module 222, an activation code receiving module 223 and an encrypting/decrypting module 224.

The anti-counterfeiting module 31 of the atomizing member 3 includes a protocol module 311, a flow control module 312, a dynamic password module 313, a fixed password module 314, a heating wire control module 315 and a data reading/writing module 316.

When the main body 2 and the atomizing member 3 perform the mutual interpretation operations, the anti-counterfeiting decoding module 21 of the main body 2 firstly sends a protocol password to the anti-counterfeiting module 31 of the atomizing member 3, and one different and encrypted protocol password is generated every time.

After the anti-counterfeiting module 31 of the atomizing member 3 has received and verified the protocol password sent from the main body 2 as correct, the anti-counterfeiting module 31 generates a dynamic password sent to the anti-counterfeiting decoding module 21 of the main body 2, and one different and encrypted dynamic password is generated every time.

Each of the anti-counterfeiting decoding module 21 of the main body 2 and the anti-counterfeiting module 31 of the atomizing member 3 includes a 56-bit serial code and an 8-bit check code.

The main body 2 is connected to the smart handheld device 4 through a bluetooth communication protocol.

Before the intelligent electronic atomization device 1 is used, the intelligent electronic atomization device 1 is connected to the smart handheld device 4 of the user through the wireless communication module 22 of the main body 2, and the application software 41 is connected to the cloud server 5 to perform registration, to verify, satisfy and eliminate the management restriction, and to generate an activation password. After the activation code receiving module 223 has received the activation password, the encrypting/decrypting module 224 performs decoding and determining to activate the main body 2.

As mentioned hereinabove, the smart handheld device 4 is connected to the wireless signal transceiver module 221 of the wireless communication module 22. After the connection, the user needs to firstly link to the cloud server 5 through the application software 41 of the smart handheld device 4 to sign in and perform associated identification and verification procedures. After the user identification has been verified, the cloud server 5 sends out a signal to the smart handheld device 4, and the smart handheld device 4 transfers a wireless signal to the wireless communication module 22 of the main body 2. The activation code receiving module 223 generates an activation password only at this time to perform the subsequent operation.

In addition, after the user has signed in and performed identification and verification procedures through the application software 41 of the smart handheld device 4, the data of the user can be returned to the cloud server 5 to create a file and a record, so that the identification of all users and the actual number of users can be controlled. The user cannot sign in and perform the identification and verification procedures through the smart handheld device 4 until the wireless signal, outputted from the wireless communication module 22 of the main body 2, is received.

In addition, when the user performs the identification and verification procedures through the application software 41 of the smart handheld device 4, the connection to the cloud server 5 is concurrently established. So, if the user identification recorded in the cloud server 5 is the underage user or in the recorded blacklist, the main body 2 cannot perform the activation operation. Even if the interested party transfers a counterfeit signal to the main body 2, the activation password still cannot be generated.

After the main body 2 and the smart handheld device 4 have performed the identification authentication of the user, the atomizing member 3 can be combined with the main body 2. At this time, the main body 2 is connected to the protocol module 311 of the anti-counterfeiting module 31 of the atomizing member 3 through a protocol module 211 of the anti-counterfeiting decoding module 21, a dynamic password module 212 of the anti-counterfeiting decoding module 21 firstly generates a protocol password transferred to the atomizing member 3, and the atomizing member 3 determines whether the protocol password is correct through the protocol module 311. After the protocol password has been determined as correct, the dynamic password module 313 of the anti-counterfeiting module 31 generates a dynamic password transferred to the anti-counterfeiting decoding module 21 of the main body 2. After the protocol module 211 of the anti-counterfeiting decoding module 21 has determined the dynamic password as correct, an output control module 214 is immediately waken up to provide a driving current to the atomizing member 3. The atomizing member 3 firstly receives the driving current through the heating wire control module 315 of the anti-counterfeiting module 31, and finally the driving current is transmitted to the heating module 32 to heat and atomize the smoke oil.

As mentioned hereinabove, because the protocol password of the anti-counterfeiting decoding module 21 is generated by the dynamic password module 212, a different and encrypted protocol password is sent to the anti-counterfeiting module 31 every time. Similarly, the dynamic password sent from the anti-counterfeiting module 31 to wake up the anti-counterfeiting decoding module 21 is also generated by the dynamic password module 313, and a different and encrypted dynamic password is generated every time. That is, even if the same main body 2 and the same atomizing member 3 are used, different protocol passwords and different dynamic passwords are outputted at many times. Thus, even if the interested party skims one set of protocol passwords or one set of dynamic passwords, the anti-counterfeiting decoding module 21 and the anti-counterfeiting module 31 still cannot operate, so that the cracking or chaining effect can be avoided.

In addition, because a driving current is needed every time when the user smokes the atomizing member 3, the data reading/writing module 316 of the anti-counterfeiting module 31 can record the usage counts of the atomizing member 3 according to the counts of providing the driving current from the main body 2. In addition, every time when the driving current is provided, one determination of the protocol password and the dynamic password between the anti-counterfeiting decoding module 21 of the main body 2 and the anti-counterfeiting module 31 of the atomizing member 3 needs to be performed, wherein the different and encrypted protocol password and the different and encrypted dynamic password are generated every time.

In addition, the user may use the same main body 2 in conjunction with different types of atomizing members 3, or use the same atomizing member 3 in conjunction with different main bodies 2. So, the exchanging usages between multiple main bodies 2 and multiple atomizing members 3 can be made through the anti-counterfeiting decoding module 21 of the main body 2 and the anti-counterfeiting module 31 of the atomizing member 3 for providing the function of interpreting the correct protocol.

In addition, the atomizing member 3 further includes other functions.

(1) The anti-counterfeiting module 31 cannot generate and send the correct dynamic password until the anti-counterfeiting module 31 receives the correct protocol password of the anti-counterfeiting decoding module 21. If the incorrect protocol password is received, then the anti-counterfeiting module 31 does not respond.

(2) The data reading/writing module 316 can record the usage counts of each atomizing member 3, and automatically destroy itself after the usage counts exceed the predetermined usage counts.

(3) When the protocol password received and the dynamic password sent for seven consecutive times are incorrect, the anti-counterfeiting module 31 automatically locks itself and disables itself from operation.

(4) The data reading/writing module 316 cannot be read/written until the received protocol password is verified as correct to prevent the interested party from acquiring or copying the data stored in the data reading/writing module 316.

(5) The data of the taste of the atomizing member 3 is recorded into the data reading/writing module 316.

In addition, the data reading/writing module 316 of the anti-counterfeiting module 31 additionally stores the manufacturing date, model, product code, brand, ingredients of the atomizing member 3 and the like information. After the atomizing member 3 and the main body 2 have been connected together, the information can be transferred to the smart handheld device 4 through the wireless signal transceiver module 221 of the main body 2. The user can browse the previous historical records of using the atomizing member 3 through the application software 41, and the information is further linked to the cloud server 5 through the application software 41, so that the consumption records of the consumers can be provided to the manufacturer, and the purposes of production, sales management and actively providing services to the consumers can be achieved.

In addition, the fixed password module 314 of the anti-counterfeiting module 31 mainly stores one set of fixed passwords, wherein the atomizing members 3 have different fixed passwords, which are similar to the product numbers and mainly provide the purposes for the manufacturer to perform the traceability management and the market tracking of the atomizing member 3.

In addition, after the smart handheld device 4 has been connected to the main body 2, the associated information of the intelligent electronic atomization device 1 can be obtained through the installed application software 41, and the optimum heating parameters can be selected or the heating power and preference settings can be self-adjusted by the user through the application software 41, so that the optimum use effect can be achieved.

Because the application software 41 is connected to the cloud server 5 at the same time, the consumer can perform the online purchase through the application software 41, or directly perform the sales behavior and the like through the community. Of course, the user can perform the gift behavior, and the grantee cannot use until the registration and activation procedures have passed. The manufacturer can achieve the purposes of the domination of the sales status, the precise production management, the delivery management, the decrease of the inventory risk and the like according to all data of the consumers linked and returned to the cloud server 5. The dealer or physical sales shop can perform the sales and order behaviors through the application software 41. So, the manufacturer and the dealer or physical sales shop may also perform the sales channel management and the direct calculation of the dividend reward through the application software 41.

In summary, compared with the existing unsolvable drawbacks that the electronic atomizer cannot effectively control the user's identification, the invention can perform the authentication of user identification and can manage the atomizing member 3 through the connections between the application software 41 of the smart handheld device 4, the intelligent electronic atomization device 1 and the cloud server 5. Furthermore, the manufacturer can achieve the purposes of anti-counterfeiting, control, sales, marketing, production management, delivery manage and the decrease of the inventory risk of the atomizing member 3 and the like through the connection to the cloud server 5. The government unit can perform the management of tax according to the number of the atomizing members 3.

What is claimed is:

1. An intelligent electronic atomization system with an authentication anti-counterfeiting mechanism, the intelligent electronic atomization system comprising:
an intelligent electronic atomization device mainly comprising a main body and an atomizing member, wherein an anti-counterfeiting decoding module and a wireless communication module are disposed in the main body, and an anti-counterfeiting module, a heating module and a sensing module are disposed in the atomizing member;
a smart handheld device, which is installed with application software, and is connected to the main body through the wireless communication module of the main body; and
a cloud server connected to the smart handheld device,
wherein before the intelligent electronic atomization device is used, the intelligent electronic atomization device is connected to the smart handheld device of the wireless communication module of the main body to perform authentication of user identification through the application software of the smart handheld device and the cloud server,
wherein after the atomizing member has been combined with the main body, the anti-counterfeiting decoding module of the main body and the anti-counterfeiting module of the atomizing member perform mutual interpretation operations in every series of inhaling and exhaling actions,
wherein after a protocol is interpreted as correct, the anti-counterfeiting module sends a dynamic password to the anti-counterfeiting decoding module to perform interpretation,
wherein after the anti-counterfeiting decoding module has interpreted the dynamic password as correct, the anti-counterfeiting decoding module immediately wakes up the anti-counterfeiting decoding module, and finally the main body transmits a driving current to the atomizing member to achieve an anti-counterfeiting objective and an objective of protecting rights, interests and securities of a manufacturer and a consumer,
wherein the intelligent electronic atomization device can be managed and all information can be linked to the cloud server to let the manufacturer actively provide a consumer service through the application software of the smart handheld device.

2. The intelligent electronic atomization system with an authentication anti-counterfeiting mechanism according to claim 1, wherein the main body and the atomizing member are combined in an electrical connection manner.

3. The intelligent electronic atomization system with an authentication anti-counterfeiting mechanism according to claim 1, wherein the anti-counterfeiting decoding module of the main body comprises a protocol module, a dynamic password module, a power control module, an output control module and a signal control module.

4. The intelligent electronic atomization system with an authentication anti-counterfeiting mechanism according to claim 1, wherein the wireless communication module of the main body comprises a wireless signal transceiver module, a reading/writing module, an activation code receiving module and an encrypting/decrypting module.

5. The intelligent electronic atomization system with an authentication anti-counterfeiting mechanism according to claim 1, wherein the anti-counterfeiting module of the atomizing member comprises a protocol module, a flow control module, a dynamic password module, a fixed password module, a heating wire control module and a data reading/writing module.

6. The intelligent electronic atomization system with an authentication anti-counterfeiting mechanism according to claim 1, wherein when the main body and the atomizing member perform the mutual interpretation operations, the anti-counterfeiting decoding module of the main body firstly sends a protocol password to the anti-counterfeiting module of the atomizing member, and one different and encrypted protocol password is generated every time.

7. The intelligent electronic atomization system with an authentication anti-counterfeiting mechanism according to claim 1, wherein after the anti-counterfeiting module of the atomizing member has received and verified a protocol password sent from the main body as correct, the anti-counterfeiting module generates the dynamic password sent to the anti-counterfeiting decoding module of the main body, and one different and encrypted dynamic password is generated every time.

8. The intelligent electronic atomization system with an authentication anti-counterfeiting mechanism according to claim 1, wherein each of the anti-counterfeiting decoding module of the main body and the anti-counterfeiting module of the atomizing member comprises a 56-bit serial code and an 8-bit check code.

9. The intelligent electronic atomization system with an authentication anti-counterfeiting mechanism according to claim 1, wherein the main body is connected to an external smart handheld device through a bluetooth communication protocol.

10. The intelligent electronic atomization system with an authentication anti-counterfeiting mechanism according to claim 1, wherein the smart handheld device is connected to the cloud server via WIFI.
